(19) United States
(12) Patent Application Publication
(10) Pub. No.: US 2007/0192363 A1
(43) Pub. Date: Aug. 16, 2007

(54) Document-centric application environment

(75) Inventor: Peter S. Larsen, Duvall, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/311,117

(22) Filed: Dec. 19, 2005

(51) Int. Cl. G06F 17/00

(52) U.S. Cl. 707/104.1

(57) ABSTRACT

An aspect-oriented document that controls both the granularity of functionality and content integration. As such, embodiments of the innovation enable programmatic interoperability prompted via the content of a document. The document-centric environment can utilize an aspect-oriented document component that controls/dictates appropriate expert applications based at least in part upon content of the data. These aspect-oriented documents shift the focus from the application to the data. As such, in this novel environment, many applications can operate on the same data file, each doing its piece. A novel feature of the innovation is a collaboration model where fragments of project information are each maintained with expert applications or applets and can expose data to each other to tie different dimensions together.

### BACKGROUND

Today, many software applications are packaged into very cumbersome monolithic applications. These monolithic applications are oftentimes equipped with an abundance of functionalities that include tools that are only accessed by a very small percentage of the users. By way of example, a conventional word processing application can contain functionalities such as mail merge and macro capabilities not usually accessed by an average user. In most cases, users are not even aware of the scope of functionalities let alone know how to use them.

Many ordinary computer users barely scratch the surface in their use of the software and operating system platform to assist in their private and professional lives. Development of these monolithic applications is a major barrier to the development cycle as well as to selling software. For instance, today, it is not uncommon for a release of a monolithic application to take years to complete before reaching the public. This time lag impedes technological progress. As well, these monolithic applications constrain advances by many innovative developers simply due to incompatibility issues.

Although the technologically savvy user is doing great with today's monolithic software approach, a majority of users are not using most of the software they have available in these large applications. Because users do not regularly use some of the features and functionalities available in today's applications, it is not uncommon that they oftentimes forget about the availability of such features and resort to alternative sources and/or applications to accomplish a task.

The trend in today's software environment is to establish an application paradigm that could facilitate not only better software and user experience, but a vendor and community fed explosion in the availability of software functionality. Over the years, the software companies have semi-successfully taught the customer to pick up dedicated software tools to perform certain tasks. For example, the customer will use a spreadsheet application for certain formulaic operations and word processing applications for other text-based operations. However, as soon as they turn their focus away from the monolithic application to the interesting business specific problem of creating complex content, the single application paradigm starts getting in the way. This is because oftentimes the monolithic application vendor does not always provide the best functionality the industry can offer in every given field. Being the best in every field is simply impossible. Rather, the user is often faced with settling for the second best or knitting together content developed using multiple applications.

To software developer's reuse, encapsulation and delegation, technologies have long been used to mitigate the uncertainty of uncharted functional territory. Many technologies and frameworks have been created in an attempt to codify aspects of such approaches, but seldom has it been done with the end user in mind.

Exemplary conventional software technologies include Object Linking and Embedding (OLE) for object granularity and limited interoperation which does provide a particular user interaction paradigm with embedding. However, conventional systems have many drawbacks and shortcomings with respect to programmatic interoperability. Toolbars have been used for functional grouping with the user in mind which on one hand seems convenient, but on the other hand confusing as they mix context specific and global functions. With the exception of toolbars, conventional technologies are mostly hidden from the user and does not change the fundamental way people work.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one embodiment thereof, comprises aspect-oriented documents that address both the granularity of functionality and content integration. The novel concepts of the innovation allow for an extension of the existing application paradigm but further open up the playing field for specialized functionality provided by vendors through software development kits. As such, embodiments of the innovation enable programmatic interoperability which is employable by an average user.

In other words, a document-centric environment can utilize an aspect-oriented document component that controls/dictates appropriate expert applications based at least in part upon content of the data. This is contrary to the application-centric environment of conventional systems. In one particular embodiment, these aspect-oriented documents can break the cycle of the application-centric monolithic applications while allowing for the old titans to add value but at the same time break the dam and allow for an explosion of creativity in the office document arena.

Aspect-oriented documents shift the focus from the application to the data. As such, in this novel environment, many applications can operate on the same data file, each doing its piece. A novel feature of the innovation is a collaboration model where fragments of project information are each maintained with expert applications or applets and can expose data to each other to tie different dimensions together.

In one particular embodiment, a calendar aspect will connect to the due dates and the due dates will connect to a Gantt chart and individual design documents. This novel functionality can allow documents to become richer by allowing the appropriate application to work on the appropriate piece of data. By way of example, although a user can create a drawing in word processing application, they may be better off creating the drawing in a graphics or diagram application. Moreover, in this embodiment, it may be advantageous to add symbols (e.g., links) within the graphics application that link to chapters of the word processing document.

In one particular embodiment, exposing data between document aspects could be accomplished via an extensible markup language (XML) metaphor even if XML is not used directly. With respect to this embodiment, all that is needed is a lowest common denominator that allows for structured data to be communicated.

In yet another embodiment, there can be an event model implied which in a publish/subscribe manner can notify interested document aspects about changes to other aspects so they can perform a necessary update. This collaborative mechanism can ensure that embedded aspects stay up-to-date with respect to changes in content.

In yet another embodiment, the novel innovation can provide for componentization of functionality. In other words, rather than have an application show or hide toolbars, the novel aspect-oriented documents can dictate the need for particular toolbars by the content. Stated another way, the document drives the application and not the other way around.

In yet another aspect thereof, an artificial intelligence (AI) component is provided that employs a probabilistic and/or statistical-based analysis to prognose or infer an action that a user desires to be automatically performed. A rules-based logic component can also be provided, alone or in combination with the AI described above to further effectuate and/or automate functionality.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates a document-centric environment in accordance with an embodiment of the novel innovation.

FIG. 2 illustrates an architectural diagram of a system that employs an analyzer component, a consolidation component and a linking component to effect a document-centric environment in accordance with an embodiment.

FIG. 3 illustrates an exemplary aspect-oriented document that depicts interoperability between applications in accordance with an aspect of the innovation.

FIG. 4 illustrates an exemplary aspect-oriented document that depicts the novel multiple instancing in accordance with the novel subject matter.

FIG. 5 illustrates an exemplary environment that facilitates interoperability between a local and a remote system in accordance with an embodiment.

FIG. 6 illustrates a block diagram of a system that employs the novel functionality in a legacy system by nesting applications and simulating the file system in accordance with an embodiment.

FIG. 7 illustrates an architectural block diagram of a document-centric environment that includes both aware and unaware applications use AOOD in a distributed environment in accordance with an embodiment.

FIG. 8 illustrates an architecture including an artificial intelligence-based component that can automate functionality in accordance with an embodiment of the novel innovation.

FIG. 9 illustrates an exemplary flow chart of procedures that facilitate aspect-oriented interoperability in accordance with an embodiment of the innovation.

FIG. 10 illustrates a block diagram of a computer operable to execute the disclosed architecture.

FIG. 11 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

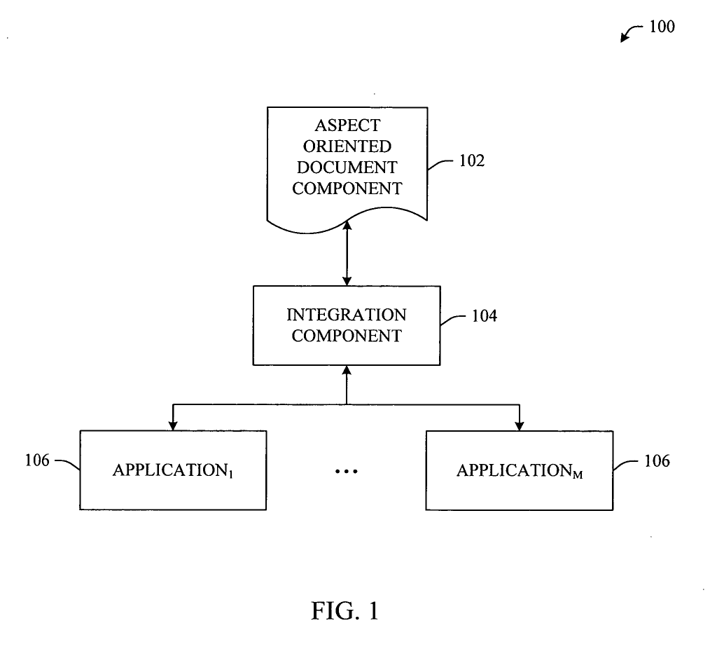

Referring initially to the drawings, FIG. 1 illustrates a document-centric system environment 100 in accordance with an embodiment of the novel innovation. Aspect-oriented documents as described herein can offer a new document-centric user interface paradigm that can empower a user and leverage the gene pool of inventive third-party software manufacturers who will be able to enter the mainstream market much easier as the bar for critical functionality mass can be lowered.

Generally, system 100 can include an aspect-oriented document component 102 that can communicate, via integration component 104 to one or more disparate applications. As illustrated, system 100 can include 1 to M disparate applications, where M is an integer. It is to be understood that 1 to M applications can be referred to individually or collectively as applications 106. It is further to be understood that applications 106 can be monolithic applications and/or functionally-focused applications. These disparate aspects will become more apparent upon a review of the figures that follow.

Although many of the embodiments described herein are directed to office applications (e.g., word processors, spreadsheets, graphics, projects), it is to be understood that the novel document-centric concepts described herein can be applied to any computer-implemented environment including, but not limited to manufacturing, purchasing, office, industrial systems, computer aided design (CAD), security, authentication, etc. without departing from the novel document-centric concepts described herein.

This disclosure describes many novel benefits of combining lean functionality components (e.g., applications 106) with a collaborating and document-centric, application paradigm (e.g., aspect-oriented document component 102) that could facilitate, not only better software and user experience, but a vendor and community fed explosion in the availability of software functionality.

At least three forces make this idea interesting. A first driving force is the availability and adoption of smaller and more agile application components 106 (e.g., office solution components) in the open source world that oftentimes contrast with monolithic applications. In other words, vendors are presented with the challenge of getting ordinary users to utilize more features of rich monolithic applications already licensed, and the challenge of entering even more specialized professional arenas with “standard” software. Additionally, monolithic application software companies constantly battle the consequences; a large and growing code base has affected application stability and agility. The monolithic approach has proven to work to hinder other entrants, but this strategy is being watered down as the playing field is leveled. From packing every conceivable feature into one application, the next frontier might very well be the ubiquitous availability of features for whatever task the customer is trying to accomplish.

To this end, the monolithic software vendor, has semi-successfully taught the customer to pick up dedicated software tools to perform certain tasks. For example, the user will use spreadsheet applications for certain things and word processing applications for others. However, as soon as the user turns focus away from the monolithic application to the interesting business specific problem of creating complex content, the single application paradigm starts getting in the way, because monolithic application vendors do not always provide the best the industry can offer in every given field.

Being the absolute best solution for everyone is simply impossible. Rather, the user is frequently faced with settling for the second or third best or manually knitting together content with multiple applications. Although the aforementioned discussion relates to replacing monolithic application with leaner, more functionality focused applications, it is to be appreciated that the document-centric novel concepts can be applied to other scenarios including monolithic applications, lean functionally focused applications, or any combination thereof.

In doing so, this disclosure describes a novel system 100 that employs attributes of a solution referred to herein as Aspect-oriented Office Documents (AOOD). Again, although the specific embodiments described herein are directed to office-focused applications, it is to be understood that the novel document-centric environment can be applied to any computer-implemented system without departing from the spirit and scope of the innovation described herein and claims appended hereto. These alternative embodiments are to be considered a part of this disclosure and claims appended hereto.

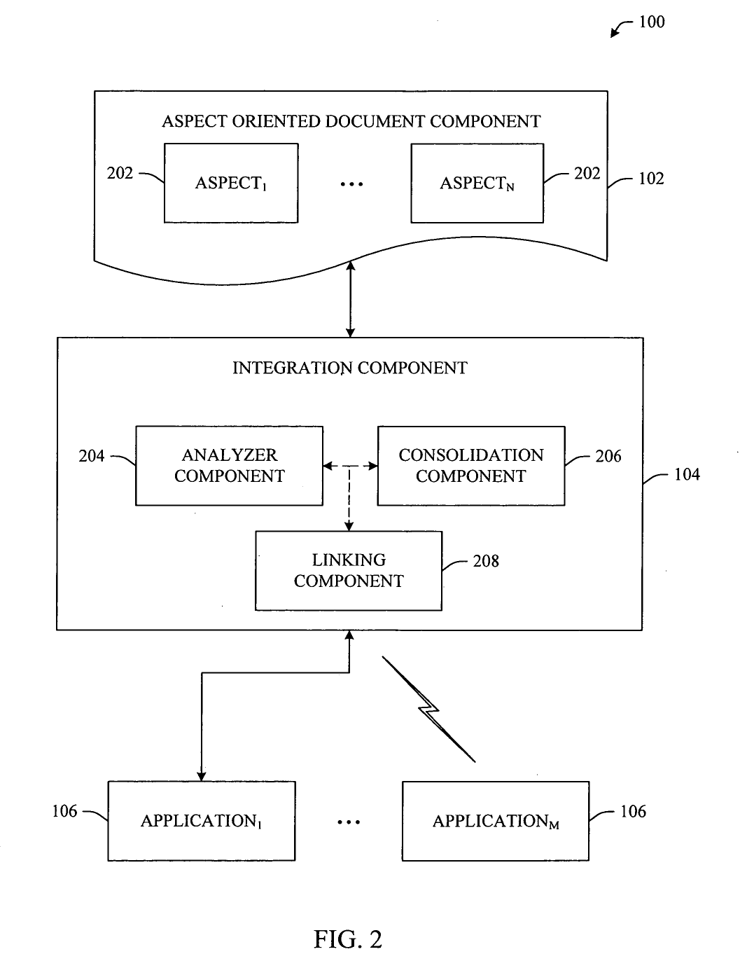

Referring now to FIG. 2, an alternative architectural block diagram of a system 100 that facilitates a document-centric application environment is shown. As illustrated, the aspect-oriented document component 102 can include 1 to N aspects, where N is an integer. Each of these aspects can be referred to individually or collectively as aspect 202. For example, one aspect 202 can refer to a flow diagram. Another aspect 202 can refer to textual content of a document. Still other aspects 202 can refer to additional functionalities included within a document including, but not limited to, a security feature, an authentication feature, graphical functionality, etc. Essentially, the aspects 202 illustrated in FIG. 2 can be considered representative of individual functionalities irrespective of a granularity. In other words, these aspects 202 can be viewed as application-specific instances within a document (e.g., aspect-oriented document component 102).

This AOOD, or aspect-oriented document component 102, can be the central focus of a user's work. Application functionality used to maintain these intelligent documents (e.g., 202) can be made available in smaller portions than in typical monolithic applications, even if provided by monolithic servers in the background. The different fragments 202 of a document can have a greater awareness of sibling aspects in the same document than is achievable with conventional monolithic application-centric technologies.

As described supra, many ordinary users barely scratch the surface in their use of the conventional monolithic platform to help them in their private and professional lives. One of the ways that the barrier can be broken down is by introducing functionality to the user a little at a time and/or as needed. This approach is different from, but not inconsistent with, releasing giant and impressive (e.g., monolithic) software applications.

Furthermore, one of the biggest impediments to uptake is getting people to use new software they have never touched before. Hence, the described innovation contemplates and discloses a common application look and feel whereby multiple applications 106 can be utilized via a single aspect-oriented document component 102. As illustrated, these applications 106 can be local and/or remote from the aspect-oriented document component 106. In one particular example, the application can be resident to the same machine or device as the aspect-oriented document component 102. In another embodiment, the application 106 can be accessed remotely (e.g., via the Internet).

This accessibility can be accomplished through the use of supply controls and toolbars which can help to break down the adoption barrier. Effectively, in an embodiment, the subject system 100 discloses a document-centric solution that pushes intimidating feature rich applications (e.g., 106) into the background. As described above, these applications 106 can be more functionally streamlined applications. As well, these features can continue to be packaged as large applications, so long as they, over time, become capable of serving up their functionality in a more granular fashion. The description herein of AOOD discloses an improved way of using documents that will both allow users to be more productive and more reliant upon the monolithic platform while adopting new functionality at a quicker pace.

One particularly novel feature of the subject innovation shifts the focus from the application to the data. In this scenario, many applications 106 can operate on the same data file 102, each doing their piece. This can be accomplished through the use of a common format. Moreover, as illustrated, the integration component 104 can include an analyzer component 204, a consolidation component 206 and a linking component 208. In accordance with this collaboration model (e.g., system 100), the aspects 202 of a document 102 or project information, each maintained with expert applications 106, can expose data to each other to tie different dimensions together.

By way of example, a calendar aspect can connect to due-dates and the due-dates can connect to a Gantt chart and individual design documents. In this example, one goal is to allow a document 102 to become richer by allowing the appropriate expert application 106 to work on particular pieces of data in a better and less intimidating way than offered today. By way of further example, today a user can create a drawing in a word processing application, but it may be easier and more effective to use a graphical application which in turn can generate a table that probably should be maintained by a spreadsheet application. It is to be understood that the subject innovation makes this novel aspect-oriented functionality available.

In operation, each of the aspects 202 associated with the aspect-oriented document component 102 can be analyzed by the analyzer component 204. In turn, the consolidation component 206 can aggregate fragments that correspond to a particular expert application 106. As such, linking component 208 can be employed to initiate the appropriate application 106 with respect to the data fragment 202 or group of fragments. As described above, it is to be understood that all, or a subset of the applications 106 can be located remote from the aspect-oriented document component 102. As well, in another embodiment, it will be understood that the individual data that corresponds to an aspect 202 can be located in disparate locations from one another. In this alternative aspect, the consolidation component 206 can be employed to locate and consolidate data fragments that correspond to a particular expert application.

Vendors of monolithic software are not in a position to define what it means to work in the electronic office. A conventional interface paradigm employs an antiquated application centric paradigm. The subject system 100 can deliver not only a better work experience with AOOD, but can also define a new kind of electronic platform on top of the operating system (OS) platform.

As such, the subject innovation discloses a change to the notion of a software document to an amorphous entity that simultaneously could be schedulable, versionable, illustrative, number-crunching, conceptual, accessible, detailed, business oriented, technical etc., for example, the aspect-oriented document component 102. By way of example, corporate team members who use electronic documents, may employ one or more of these aspects 202 of the information at one time or another. Accordingly, because of the novel interoperability, data can be maintained current across applications 106 via aspects 102 embedded therein.

One of the important “aspects” of this approach (e.g., system 100) is the componentization of functionality. Rather than merely have a single application show or hide toolbars, the subject innovation, via the aspect-oriented document component 102, can dictate the initialization/utilization of particular functionality (perhaps in toolbars) based upon the characteristics of content. In other words, the analyzer component 204 can evaluate the individual aspects 202 of the aspect-oriented document component 102. Thereafter, the consolidation component 206 and the linking component 208 can be employed to link an appropriate application 106 to a particular fragment of data from the aspect-oriented document component 102. In other words, in accordance with the innovation, the document (e.g., 102) drives the application (e.g., 106) and not the other way around.

In one aspect, the subject system 100 can employ extensible markup language (XML) mechanisms to effect the document-centric environment. As will be understood, the XML technology has taught the developer community valuable lessons once known only to people in a few vertical fields. As such, XML has brought data modeling to a wider audience and provided an industry standard for interfacing between diverse software. Therefore, XML, as a paradigm at least, can be particularly important in embodiments of this subject system 100 solution because is affords technological benefits.

For example, XML affords reflection which enables software to inspect the composition of data and react in real time to structure and content. This mechanism can enable the integration component 104 (e.g., analyzer component 204, consolidation component 206 and linking component 208) to inspect and react to data fragments and aspects 202 of the aspect-oriented document component 102. Additionally, XML can facilitate interchange which refers to the export and import between widely different packages (e.g., applications 106). As well, XML can support extensibility which refers to an ability for applications arriving later to support derived models.

In addition to the aforementioned benefits, XML can provide a number of useful technologies for referencing content. For example, XSD (XML Schema Definition) can be employed to provide document definition (with convenient inheritance). XLink (XML Linking Language) can be utilized to provide double linked pointers making both endpoints aware. As well, XQL (XML Query Language) can express complex selection(s) of nested content. Additionally, SOAP (Single Object Access Protocol), while not XML per se, can allow remoting mechanisms with respect to XML data.

It will be appreciated that XML is often more useful as a definition language than a wire or storage format. This is partly because of the expensive nature of XML and partly because straight XML implementations are easily co-opted. Moreover, although the discussion above is directed to a straight XML implementation, it is to be understood that XML mainly serves as metaphor and that alternative embodiments exist without departing from the spirit and scope of this disclosure. These additional embodiments are to be included within the scope of this disclosure and claims appended hereto.

Essentially, the exemplary system 100 of FIG. 2 can include storage which allows for complex component oriented documents (e.g., aspect-oriented document component 102) to be worked on in part by multiple applications 106. In other words, as described supra, in disparate aspects, the applications 106 can be representative of expert functionality focused applications, monolithic applications or any combination thereof. As well, these applications 106 can be local and/or remotely located with respect to the aspect-oriented document component 102.

In one embodiment, the interface layer (e.g., integration component 104) can be hosted by a host. For example, the integration component 104 can be hosted by an existing office application 106. As well, in other aspects, the integration component can be a stand-alone component (e.g., not hosted by another application). The integration component 104 can further provide a notification system (e.g., via consolidation component 206 and linking component 208) that can allow expert applications 106 to communicate inside the document 102. The linking component 208 can include an interface definition that can allow document parts to explicitly expose information to other document parts (e.g., document fragments). In another embodiment, the integration component can include an application program interface (API) that facilitates the storage, notification, interface definition. These mechanisms will be better understood upon a review of the figures that follow.

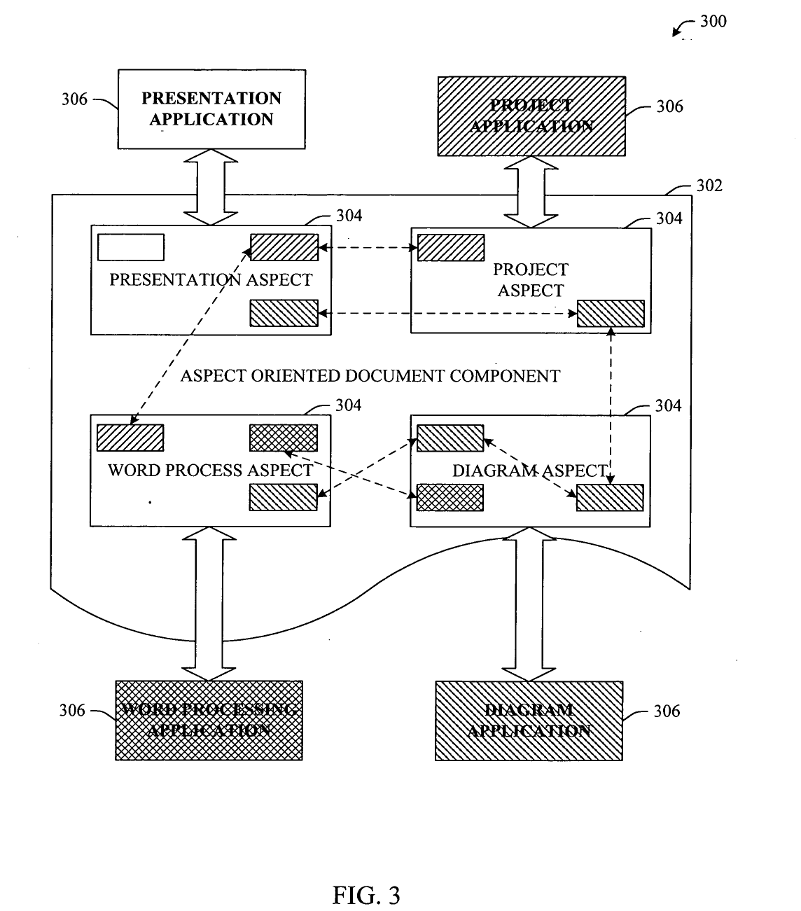

Turning now to FIG. 3, an alternative system 300 in accordance with an aspect is shown. More particularly, FIG. 3 illustrates the interoperability between applications 106 with respect to the aspect-oriented document component 302. It is to be appreciated and understood that the particular aspects 304 and applications 306 shown in FIG. 3 are provided to convey perspective of the novel functionality. As such, these particularly applications are not intended to limit the innovation in any way.

With continued reference to FIG. 3, an aspect-oriented document component 302 is shown. The aspect-oriented document component 302 includes aspects 304 that can be representative instances of a number of disparate applications 306. More particularly, as shown, the aspect-oriented document component 302 can include a slide-ware aspect 304 associated to a presentation application 306, a timeline aspect 304 associated to a project application 306, a word process aspect 304 associated to a word processing application 306 and a graphical aspect 304 associated to a diagram application 306. Although the embodiment illustrated in FIG. 3 employs four disparate, yet functionally-specific applications 306, it is to be understood that any number of known and unknown applications can be integrated into an aspect-oriented document component. It is further to be understood the each of the applications (e.g., 306) share a method to manipulate the aspect-oriented document component 302 and share a common user interface for maintaining “aspects.”

In an aspect, the master document 302 itself has very limited functionality. Its main role is providing a container for traditional document storage and more importantly, provide for smart linking between the various documents. This smart-linking functionality can be facilitated via linking component 208 as described supra with reference to FIG. 2. It should be understood that the innovation described herein discloses an application 302 capable to facilitate direct management of aspects 304. Additionally, the novel functionality can be employed through interfaces of the main applications 306 such as word processing applications which owns particular aspects 304 as illustrated.

FIG. 3 illustrates a complex document (e.g., aspect-oriented document component 302) that can describe a project with a number of different kinds of data involved (e.g., aspects 304). For example, the presentation application 306 can be used for slide-ware, the project application 306 can be used for a timeline and resource planning, the word processing application 306 can be used for the majority of the text and the diagram application 306 for the drawings.

Although with limited functionality, conventionally, limited content interoperability has been accomplished through Object Linking and Embedding (OLE) or perhaps depending on the publication format, the various inserted content pieces have been converted to bitmaps. However, these conventional approaches present some unique challenges. For example, in conventional systems, different parts of a document cannot be linked across content types to replicate updates from one place to another. As well, each type of content invokes their dedicated application with oftentimes different implementations of doing the very same thing. In other words, in accordance with these conventional approaches, data is not universally updated with respect to disparate applications.

As well, another drawback of conventional approaches is that the user is acutely aware that some other “big” engine has kicked into gear, instead of just providing the desired functionality as is possible in accordance with the subject innovation. As shown in FIG. 3, interoperability between aspects 304 of the aspect-oriented document component 302 are depicted by the fill format of the instance squares shown in each of the aspects 304. As shown, each aspect 304 of the aspect-oriented document component 302 can share and access functionality from other applications 306.

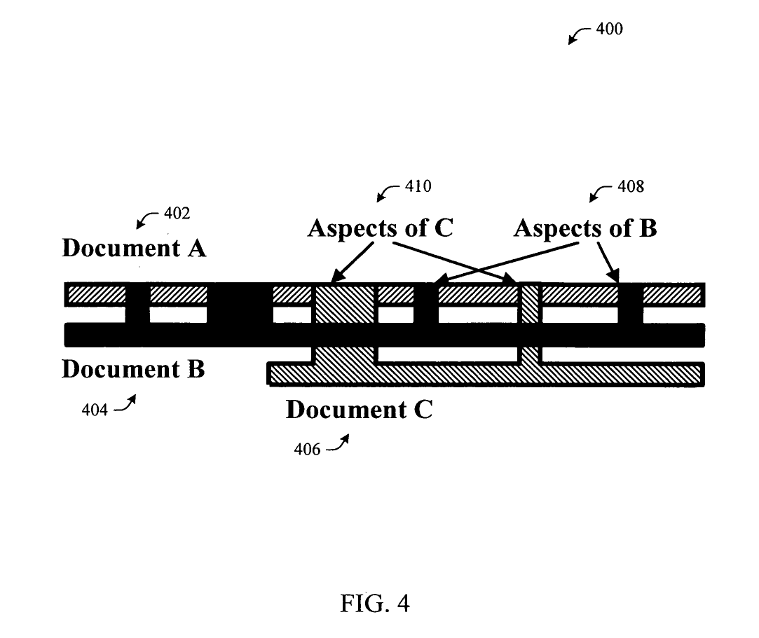

By way of example and not limitation, as shown, fragments associated with the project application 306 can be employed by disparate aspects 304 (e.g., project aspect, presentation aspect and text aspect). Similarly, multiple fragments related to the diagram application 306 can be accessed via the diagram aspect, project aspect, presentation aspect and word processing aspect. Moreover, as shown, aspects (e.g., diagram aspect) can include more than one fragment associated with a particular application aspect. This novel integration will be better understood upon a review of FIG. 4 that follows.

In conventional OLE systems, reference is made to entire documents which in some cases is convenient, but in many cases not at all. For practical reasons, it can be particularly useful to reference parts of a document, for example pieces of spreadsheets, rather than the document as a whole. This fragment reference is one novel feature of the subject innovation. Additionally, oftentimes a user may want to quote or reference a single document more than once in another document. This scenario is not possible in typical OLE embedding. The ability to effectuate multiple references to a document or fragment within a disparate application thereof is yet another novel feature of the innovation.

Referring now to FIG. 4, a schematic of an exemplary document integration 400 is shown. Generally, the document integration 400 illustrates the integration principle between Document A 402, Document B 404, and Document C 406. As illustrated, multiple instances of Document B and Document C are illustrated (e.g., 408, 410 respectively) and integrated (e.g., embedded) into Document A 402 via the novel mechanisms described herein. It will be appreciated that conventional OLE approaches will only permit a single aspect of each Document B 404 and Document C 406 to be integrated into Document A 402. Moreover, as described supra, as data is updated within a particular document, the updates can be perpetuated via embedded aspects as shown.

Although conventional approaches (e.g., OLE) can provide a limited model for in place editing of embedded objects, these approaches lack novel attributes disclosed and claimed herein. For example, as illustrated in FIG. 4, the subject innovation can provide multiple instance embedding between multiple documents. Additionally, as described above, the subject innovation can provide both remote and local content associated to disparate applications via a single aspect-oriented document component. Moreover, the innovation can provide explicit information sharing between involved document fragments. In other words, the data can be kept up-to-date by simply modifying the data within a single application. When accessed via a disparate application, the application will render the updated data.

It will be appreciated that providing embedded pieces from another document (and possibly type) can be particularly convenient in larger projects where each body of work is substantial and takes time to produce. Consider as an example the desire to quote pieces of graphic schematics that have multiple diagrams connected and structured by other diagrams or a spreadsheet with many hidden calculations. Allowing this type of embedding remotely effectively implies distributed objects, but the scope could be reined into a simpler client server solution where only content owned by a content server could be quoted and reused in this way. The potential exists to have documents updated as facts outside them change.

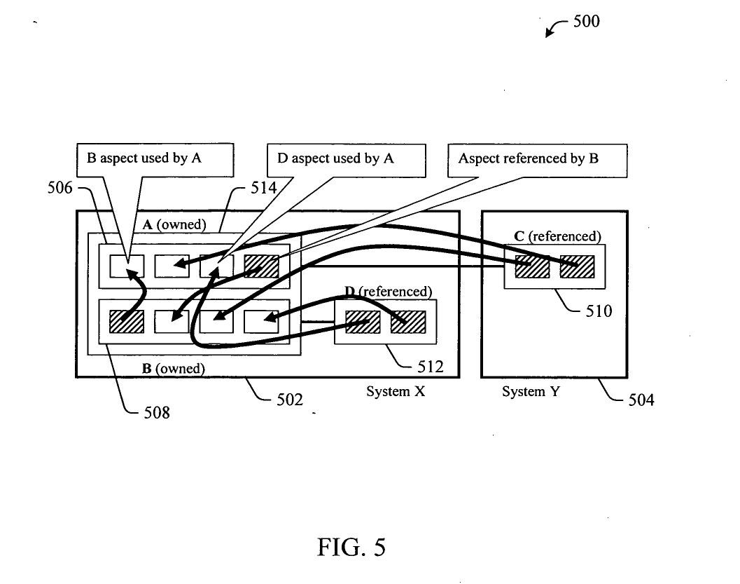

Referring now to FIG. 5, a graphical representation 500 is illustrated that depicts owned and referenced content shared between documents. Generally, the graphical representation 500 shows system X 502 a system Y 504 each having documents associated therewith. More particularly, Document A 506, Document B 508, Document C 510 and Document D 512 can be distributed in connection with the systems 502, 504 as shown.

For the purpose of this discussion, “owned” content is stored entirely within the aspect-oriented document component 514 and “referenced” content is store entirely outside the aspect-oriented document component 514. There is a fundamental difference between referencing content that is owned by another entity (e.g., 510) and fully owning the content referred to (e.g., 506, 508, 512).

In one aspect, referenced content can change at any moment and links and/or perhaps cached copies can be stored locally. FIG. 5 depicts a mixture of local and remote aspect references. As shown, remote aspects can reside anywhere on the network, but as previously mentioned, there may be advantageous reasons to limit availability to particular content servers. “Referenced” and “owned” content can be both referenced by the same type of pointers in the aspect-oriented document component 514. Accordingly, the location context identifies the content as being “referenced” or “owned.” When external content is referenced (e.g., 510), it can be particularly desirable to store local (read only) snapshots of the referenced data which may be offline or no longer in existence analogous to thumbnails or previews.

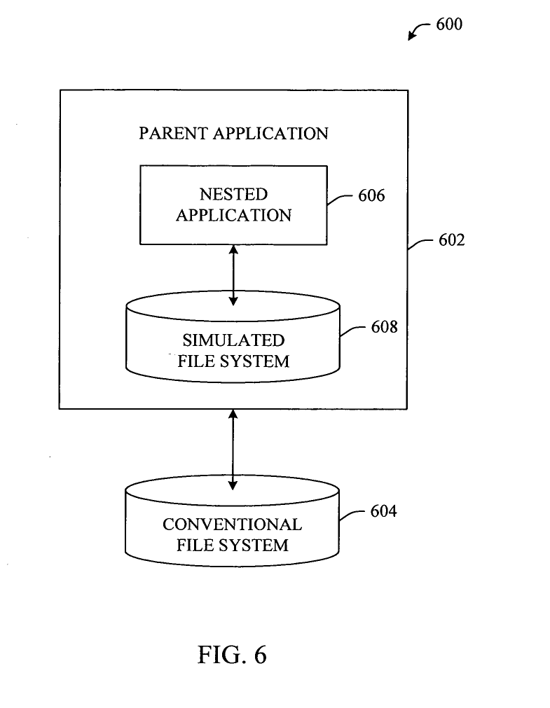

FIG. 6 illustrates a block diagram of a system 600 that facilitates a document-centric environment in accordance with an aspect of the innovation. In order to make AOOD pervasive, it can be useful to enroll older applications (e.g., legacy) that have no knowledge of AOOD into the fold. One of the novel features the subject innovation is component storage which facilitates keeping all aspects of a complex document in one unit. To achieve this collaborated storage for applications that are unaware of AOOD, a mechanism of proxying a file system inside another type of storage can be employed. FIG. 6 illustrates a mechanism of storing files to a particular path which is simulated inside a file owned by an AOOD-aware application.

As described above, the subject system 600 can deliver not only a better work experience through the use of novel document-centric mechanisms, it can also define a new kind of electronic application platform 602 that can sit on top of the conventional OS platform 604. As shown, the document-centric application platform 602 can include a nested applications component 606 and a simulated file system component 608 for carrying out the novel functionality described herein.

Turning now to a discussion of the aspect-oriented document functionality as employed in legacy and other applications, in an aspect, original document types can be employed with the aspect-oriented document file structure to achieve useful functionality. Permitting this use of original document types facilitates both backward and forward compatibility.

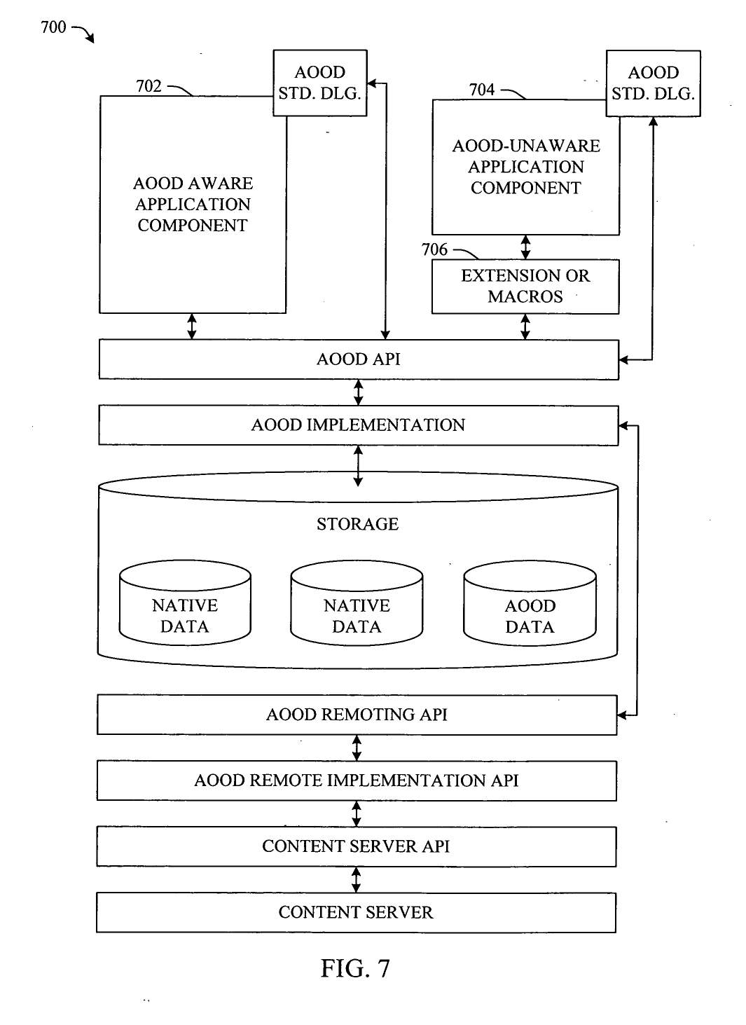

Allowing original document types intact inside the aspect-oriented document component file structure 608 can achieve many benefits. These benefits will become more apparent upon a review of FIG. 7 that follows. As stated previously, although many of the embodiments described herein describe office application implementations, it is to be understood that other embodiments exist which apply aspect-aware functionality to other types of applications. These alternative aspects are to be included within the scope of this disclosure and claims appended hereto.

With reference now to FIG. 7, a system 700 that facilitates aspect-aware functionality in accordance with the novel innovation is shown. For example, in accordance with system 700, AOOD-aware 702 and AOOD-unaware 704 applications can be treated uniformly. Additionally, AOOD's 702, 704 can easily export their constituent application specific documents. Moreover, application-specific documents can be upgraded inside the AOOD by the application.

An AOOD can be operational partly from legacy applications (AOOD-unaware 704) and partly from AOOD-aware applications 704 as well as some added infrastructure as shown. The added infrastructure can appear to the AOOD user as additional standard dialogs which can deal with common tasks particular to AOOD documents such as storage management and semantic linking. This type of functionality can be provided by the “AOOD Implementation” and reached through the “AOOD API” as illustrated. For AOOD-unaware applications 704 it is possible to retrofit a certain amount of AOOD behavior through shims in the form of extension modules or macros 706 that utilize the “AOOD API”.

FIG. 7 shows at a high level the components that can be deployed in an environment where both aware and unaware applications use AOOD in a distributed environment. It is to be understood that the distribution mechanism illustrated is not intended to be limiting in any way and is not to be considered the sole thrust of the AOOD technology. To this end, the distribution mechanism is envisioned to be accomplished through other technologies, including but not limited to, .NET-brand environments with services on the remote side serving up content inside the AOOD.

In one embodiment, leveraging all the benefits of AOOD requires additional intelligence provided by a new AOOD document type. As shown in FIG. 7, for legacy applications the AOOD could make available on a temporary basis, the native file format for the application to work on. This behavior is similar to document management systems with provide check in and check out procedures. Referring back to FIG. 6, the relationship between parent 602 and nested application 606 is shown. More particularly, this relationship shows a situation where the nested application 606 is unaware that it is storing files inside of a file managed by the parent.

With reference again to FIG. 7, it may be necessary to construct adapters for AOOD-unaware applications 704 to establish pointers to their structured document material. In most cases, this can be accomplished by plug-ins for applications where external assemblies, DLL's or macros 706 can accomplish the task of mapping between the two domains.

Referring now to a discussion of technology considerations, in order to secure AOOD against being co-opted by unwanted parties (e.g., competition), it is necessary to implement AOOD with some monolithic and OS-specific technologies. In doing so in a Windows-brand environment, some technical challenges exist. A first challenge is providing sub-document referencing. Partial embedding is another challenge that can be overcome by the subject innovation.

Additionally, embodiments can address editing in place and editing stand-alone. Viewing and printing are also addressed by the subject innovation. As shown in FIG. 7, remoting, e.g., defining a networked API for referencing partial content can be facilitated. In one example, XLink can be employed to effectuate this remoting functionality. Still another challenge that can be addressed by the subject innovation is that the innovation can support existing applications with AOOD extensions and macro support

AOOD. In doing so, the following components can be employed:

An AOOD client assembly/DLL with an API invoked natively or through extensions or macros;
An AOOD management application which is typically launched as a standard dialog from other apps;
An AOOD Remoting assembly/DLL suite which supports various remote resources through their respective API's;
An AOOD aware server would also have programmatic support. This can be effected in its own assembly/DLL to be able to host AOOD's and allow them to be quoted over the network; and
A storage scheme.

The storage requirements of an AOOD are complex but structure alone could be handled by a number of technologies including, but not limited to, compound files, XML and Structured Query Language (SQL) Server. It will be appreciated that the marriage between the fundamental storage service and more complex documents can be used to raise the awareness of both.

It is to be understood that the novel embodiments described herein can leverage existing security models in order to allow selective access to aspects of a document as well as encryption. Additionally, other aspects can incorporate digital rights management in order to control access to protected content.

The following scenario is provided to add context to the innovation. As such, this scenario is not intended to limit the scope of this disclosure and claims appended hereto in any way. Rather, the use case scenario is merely provided to add perspective to this novel complex content interaction.

Consider a situation where a customer is planning a new infrastructure rollout and is intending to base the planning and execution on monolithic environments which brought a lot of templates which had to be filled over time. The project plan has aspects of regional rollout and local rollouts and these plans fold into each other with different people interested in both aspects.

Continuing with the scenario, a consulting firm is enlisted and develops a workflow for the planning and rollout processes. This workflow can be represented in a smart document that integrates with messaging and document control. In accordance with the novel functionality of the subject innovation, AOOD's can be created around each workflow which will allow the workflows to guide themselves around the content production and review path.

In the case scenario, the consulting firm is modifies the workflow using their special editing tool which is not accessible to everybody else. But a runtime version with an AOOD extension DLL knows how to get at the information and can control the flow of the document. Moreover, a template for a document can be employed to assist in the production with helpful guidance. It is to be understood that this template does not even have to be made by the same application.

The subject innovation enables additional office applications to be used in order to add system diagrams and executive presentations of parts of the system. These additional applications are included as separate strands in the AOOD and quoted where they make sense with explanatory text. Requirements in one aspect can be directly mapped to testing in another aspect.

The resulting information objects are easier to move around and there is no question about which documents go together as they are one unit. Collaboration is ensured by locating strategically chosen documents on shared servers. As documents near completion, the reviewers create an aspect of the document to capture their observations and feedback. Because of the diverse applications used, the reviewers just use a single tool but are able to attach the comments where they apply. There are multiple documents that can be printed from one AOOD. Moreover, printing may involve network access if the user wants to refresh the local snapshots of the remote data. A new aspect is added to the documents allowing the rollout to capture feedback on the plan and to fill out instance data from actual deployment. This information can be circulated back to headquarters for inventory, lessons learned and future planning.

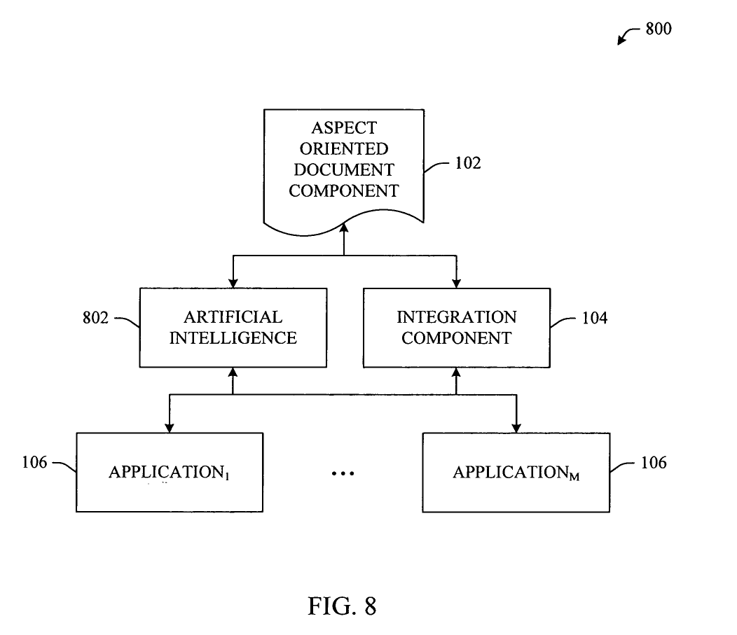

FIG. 8 illustrates a system 800 that employs artificial intelligence (AI) which facilitates automating one or more features in accordance with the subject innovation. The subject innovation (e.g., in connection with selection of an expert application component) can employ various AI-based schemes for carrying out various aspects thereof. For example, a process for determining when and/or which expert application to employ in accordance with an aspect can be facilitated via an automatic classifier system and process. Moreover, where the applications 106 are distributed over several remote locations, the classifier can be employed to determine which application to employ based at least in part upon the location and context.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria a preferred expert application in accordance with an aspect of the aspect-oriented document. Moreover, classifiers can be used to automatically learn a degree of specificity desired by a user. This determination can be used in selecting an appropriate expert application to employ in a given situation.

In still other embodiments, rules-based logic can be employed to automate and/or preprogram decisions related to the system. In accordance with this alternate embodiment, an implementation scheme (e.g., rule) can be applied to define and/or implement a query. It will be appreciated that the rule-based implementation can automatically and/or dynamically define an application with respect to a particular task. In response thereto, the rule-based implementation can select applications and embed associated aspects thereof by employing a predefined and/or programmed rule(s) based upon any desired criteria (e.g., file type, file size, hardware characteristics). It will be appreciated that any of the specifications utilized in accordance with the subject innovation can be programmed into a rule-based implementation scheme. In the exemplary embodiment, a rule engine component (not shown) can be programmed or configured in accordance with a user-defined preference.

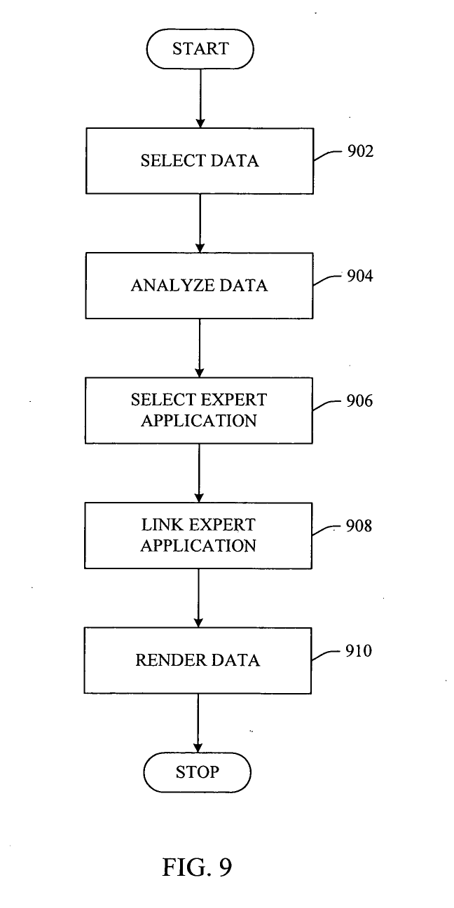

FIG. 9 illustrates a methodology of employing a document-centric environment in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

In accordance with the methodology shown in FIG. 9, a user can effectively operate upon and employ data associated with any number of disparate applications from within one aspect-oriented document. At 902, data is selected for which to operate, for example, a user can select slide-ware data. As such, at 904, the data selected is analyzed in order to determine an appropriate application (e.g., expert application) to launch. The appropriate expert application can be selected at 906 and linked at 908. Once linked, a user is then able to manipulate the data via the selected expert application.

As described with respect to the system figures above, any modification and/or generation of data will be populated into aspects and embedded as desired. In other words, upon rendering the data at 910, instances of a particular application can be included within a rendering supplied by a disparate application. More particularly, as described supra, multiple instances can be rendered thereby displaying multiple fragments (or portions thereof) of data associated with one application within another disparate application.

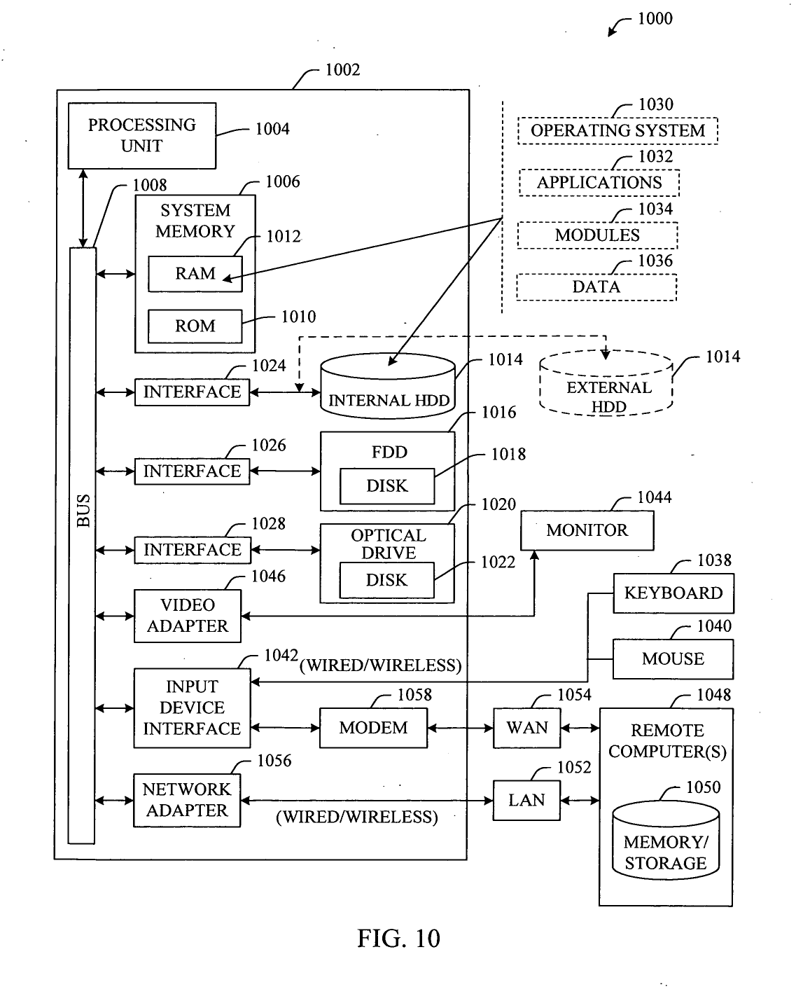

Referring now to FIG. 10, there is illustrated a block diagram of a computer operable to execute the disclosed architecture of document-centric environments. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

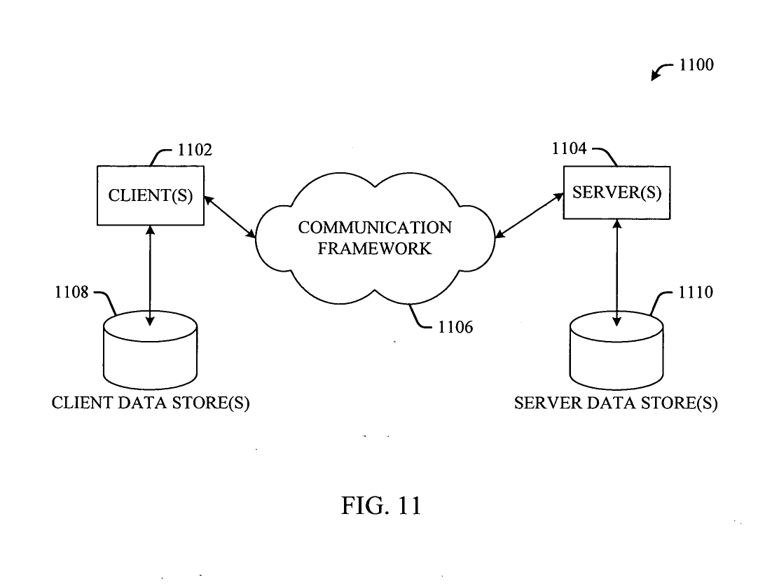

Referring now to FIG. 11, there is illustrated a schematic block diagram of an exemplary computing environment 1100 in accordance with the subject innovation of providing a document-centric computing environment. The system 1100 includes one or more client(s) 1102. The client(s) 1102 can be hardware and/or software (e.g., threads, processes, computing devices). The client(s) 1102 can house cookie(s) and/or associated contextual information by employing the innovation, for example.

The system 1100 also includes one or more server(s) 1104. The server(s) 1104 can also be hardware and/or software (e.g., threads, processes, computing devices). The servers 1104 can house threads to perform transformations by employing the innovation, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates a document-centric environment, comprising:
an aspect-oriented document component that comprises a plurality of aspects that relate to a plurality of applications; and
an integration component that embeds a plurality of data fragments that correspond to one of the plurality of aspects into the aspect-oriented document component.

2. The system of claim 1, the plurality of applications are functionality-specific applications.

3. The system of claim 1, the plurality of applications are monolithic applications.

4. The system of claim 1, the integration component further comprises an analyzer component that evaluates the aspect-oriented document and determines the one of the plurality of aspects based at least in part upon content.

5. The system of claim 4, the integration component further comprises a consolidation component that aggregates the plurality of fragments that correspond to the one of the plurality of aspects.

6. The system of claim 5, the integration component further comprises a linking component that associates each of the plurality of aspects to one of the plurality of applications.

7. The system of claim 1, at least one of the plurality of applications is located remotely from the aspect-oriented document component.

8. The system of claim 1, the plurality of applications are nested within a parent application.

9. The system of claim 1, further comprising an application program interface (API) that facilitates a user to manipulate the aspect-oriented document component.

10. The system of claim 1, the aspect-oriented document dictates utilization of one of the plurality of applications based at least in part upon content.

11. The system of claim 1, further comprising an artificial intelligence (AI) component that employs a machine learning mechanism to infer an action that a user desires to be automatically performed.

12. A computer-implemented method of rendering document-centric data, comprising:
selecting a document;
analyzing content within the document;
determining a plurality of applications associated to the content; and
rendering the content via aspects of the plurality of applications.

13. The computer-implemented method of claim 12, further comprising storing a plurality of fragments that correspond to the plurality applications in an aspect-oriented document.

14. The computer-implemented method of claim 12, further comprising embedding multiple instances of one of the plurality of applications into a disparate one of the plurality of applications.

15. The computer-implemented method of claim 14, further comprising defining the one of the plurality of applications based at least in part upon the content.

16. The computer-implemented method of claim 15, the act of defining further comprises generating a template that presupposes the one of the plurality of applications based at least in part upon the content.

17. The computer-implemented method of claim 14, further comprising inferring the one of the plurality of application based at least in part upon a user preference.

18. A computer-implemented document-centric system, comprising:
means for embedding a plurality of aspects that relate to a plurality of applications within a single document;
means for storing data related to a subset of the plurality of applications;
means for determining at least one of the plurality aspects based at least in part upon the data; and
means for rendering the data via the at least one of the plurality of aspects.

19. The computer-implemented system of claim 18, the means for determining is a template.

20. The computer-implemented system of claim 19, further comprising, means for defining the template.
